(19) United States
(12) Patent Application Publication
(10) Pub. No.: US 2006/0117160 A1
(43) Pub. Date: Jun. 1, 2006

(54) Method to consolidate memory usage to reduce power consumption

(75) Inventors: Riley W. Jackson, Portland, OR (US); Brian V. Belmont, Portland, OR (US)

Correspondence Address: INTEL CORPORATION, P.O. BOX 5326, SANTA CLARA, CA, 95056-5326, US

(73) Assignee: Intel Corporation

(21) Appl. No.: 11/002,601

(22) Filed: Dec. 1, 2004

(51) Int. Cl. G06F 12/00

(52) U.S. Cl. 711/170; 713/320

(57) ABSTRACT

A method and system for reducing power consumption of a computer system by allocating memory pages that are associated with lower memory address before those associated with higher memory addresses. Memory elements that do not include any allocated memory pages and that are positioned at a higher address than a threshold address may have its power consumption reduced when the computer system enters a low power consumption state.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention generally relates to memory management. More specifically, the present invention relates to managing memory usage to reduce power consumption.

### BACKGROUND

Over the last few years, there have been many advances in semiconductor technology that have resulted in the development of improved electronic devices having integrated circuits (IC) operating at higher frequencies and supporting additional and/or enhanced features. While these advances have enabled hardware manufacturers to design and build faster and more sophisticated computer systems, they have also imposed a disadvantage in higher power consumption, especially for battery-powered computer systems.

A variety of techniques are known for reducing the power consumption in computer systems. For example, the Advanced Configuration and Power Interface (ACPI) Specification (Rev. 2.0a, Mar. 31, 2002) sets forth information about how to reduce the dynamic power consumption of portable and other computer systems. With respect to processors used in computer systems, four processor power consumption states (C0, C1, C2, and C3) are defined in the ACPI Specification. The C0 state is a normal power consumption state. Each of the C1, C2 and C3 states is a low power consumption state. An Operating System (OS) in the computer system may dynamically transition the processor into the appropriate low power consumption state.

While the low power consumption states defined by the ACPI Specification and known techniques have many advantages, there is a continuing need for ways to further reduce the power consumption of computer systems, including power consumption of individual components such as, for example, a display, a disk drive, graphics controller, memory system, etc.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1A is a block diagram illustrating an example of a computer system, in accordance with one embodiment.

FIG. 1B illustrates an example of a memory module, in accordance with one embodiment.

FIG. 2A is a block diagram illustrating one example of a physical memory in a computer system, in accordance with one embodiment.

FIG. 2B is a block diagram illustrating one example of the memory in a computer system that uses a sorted zeroed list, in accordance with one embodiment.

FIG. 3 is a block diagram illustrating one example of a physical memory and associated memory elements, in accordance with one embodiment.

FIG. 4 is a flow diagram illustrating one example of a process that may be used to identify a memory element whose power consumption may be reduced or restored, in accordance with one embodiment.

### DETAILED DESCRIPTION

For one embodiment, a system and a method for reducing power consumption in a computer system by managing memory usage is disclosed. A memory element may include one or more memory pages. A memory page may be allocated and unavailable. At a different time, the same memory page may be available and ready to be allocated. The memory pages that are available may be sorted based on their associated memory addresses. The memory pages associated with lower memory addresses may be allocated before the memory pages associated with higher memory addresses. Power consumption of a memory element that does not include any allocated memory pages may be reduced.

In the following description, for purposes of explanation, numerous specific details are set forth in order to provide a thorough understanding of the present invention. It will be evident, however, to one skilled in the art that the present invention may be practiced without these specific details. In other instances, well-known structures, processes and devices are shown in block diagram form or are referred to in a summary manner in order to provide an explanation without undue detail.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Reference in the specification to “one embodiment” or “an embodiment” of the present invention means that a particular feature, structure or characteristic described in connection with the embodiment is included in at least one embodiment of the present invention. Thus, the appearances of the phrase “for one embodiment” or “in accordance with one embodiment” appearing in various places throughout the specification are not necessarily all referring to the same embodiment.

Computer System

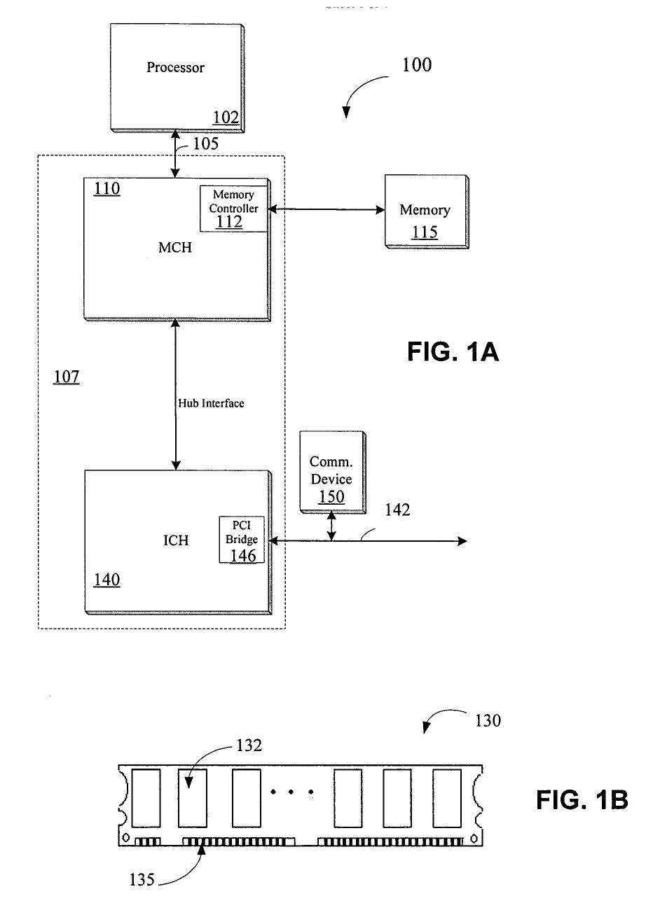

FIG. 1A is a block diagram illustrating an example of a computer system, in accordance with one embodiment. Computer system 100 may include a central processing unit (CPU) or processor 102 and may receive its power from an alternating current (AC) power source (e.g., from an electrical outlet) or from a direct current (DC) power source (e.g., from a battery). The processor 102 may be coupled to a bus 105. The processor 102 may be a processor manufactured by, for example, Intel Corporation of Santa Clara, Calif. Chipset 107 may be coupled to the bus 105. The chipset 107 may include a memory controller hub (MCH) 110. The MCH 110 may include a memory controller 112 that is coupled to memory 115 (e.g., random access memory (RAM), read-only memory (ROM), etc.). The memory 115 may store data and sequences of instructions that are executed by the processor 102 or any other processing devices included in the computer system 100.

The MCH 110 may be coupled to an Input/Output Controller Hub (ICH) 140 via a hub interface. The ICH 140 may include a Peripheral Component Interconnect (PCI) bridge 146. The PCI bridge 146 may be coupled to PCI bus 142. For one embodiment, at least one communication device 150 may be coupled to the PCI bus 142 to be used for network communications. For example, the communication device 150 may be a wireless device to support communications with other devices using a wireless standard. The wireless standard may be a wireless local area network (WLAN) standard such as, for example, the Industrial Electrical and Electronics Engineers (IEEE) 802.11 standard. The wireless standard may also be a wireless wide area network standard (WWAN), or any other wireless standards or protocols for communications using, for example, a cellular communications, satellite communications, short-range communications, etc. For one embodiment, the communication device 150 may be coupled to an antenna. Any type of antenna may be used. Although not shown, the computer system 100 may also include other components such as, for example, storage devices, a printer, a display, etc. In addition, one skilled in the art may recognize that the computer system 100 may be a lap top computer system, a personal digital assistant (PDA), a cellular phone, or any other portable devices.

Memory System

The memory 115 may include many memory elements. A memory element may be a collection of one or more memory chips (e.g., a memory module, multiple memory modules, an occupied memory bank, etc.). FIG. 1B illustrates an example of a memory module, in accordance with one embodiment. Memory chip 132 is normally soldered onto a circuit board referred to as memory module 130. There may be multiple memory chips on the memory module 130. For example, the memory module 130 may have four (4) memory chips each having a capacity of 64 megabits for a total module capacity of 256 megabits or 32 megabytes (MB). The memory module 130 may be a dual in-line memory module (DIMM), a small outline dual in-line memory module (SODIMM), or any other memory packaging formats. The memory module 130 may include multiple pins 135 (e.g., 168 pins or 184 pins) and may be inserted into a socket in the computer system 100. A group of sockets may form a memory bank. A memory bank may empty, or it may be occupied by one or more memory modules.

A memory chip is an integrated circuit (IC) made of millions of transistors and capacitors. In a DRAM, a transistor and a capacitor are paired to create a memory cell, which represents a single bit of data. The capacitor holds the bit of information, and the transistor may act as a switch that lets control circuitry on the memory chip read the capacitor or change its state. The memory controller 112 may need to periodically recharge or refresh the capacitor by reading and writing back to the memory 115. The refresh operation may happen automatically thousands of times per second. Power is supplied to the memory module 130 and the associated memory chips by the computer system 100 via a pin (e.g., V_{DD} pin). For example, the memory module 130 may have a supply voltage of 3.3 Volts.

Memory Management

When the computer system 100 relies on its battery as a power source for over a long period of time, the battery life is an important factor. Reducing overall system power consumption by one to two watts may considerably increase the battery life and operation time of the computer system 100. The memory 115 along with its memory elements may contribute to the over all system power consumption. For example, in a mobile or lap top computer system today, the memory 115 may account for approximately one to four watts of power.

An operating system (OS) may manage the memory 115 using a system that includes a physical memory, a virtual memory, and memory pages. For example, the Windows OS from the Microsoft Corporation of Redmond, Wash., supports an on-demand paging system which provides a virtual address space of 4 gigabytes (GB). This 4 GB of address space normally far exceeds the actual installed memory (also referred to as physical memory), which may be, for example, 256 MB or 512 MB. A memory page may include a starting address and may be 4 Kilobytes (KB) in size. The OS may allocate a memory page to satisfy a demand when there is a free memory page in the physical memory. Alternatively, the OS may perform memory swapping by moving a memory page from the physical memory to the virtual memory which may include space in a disk storage device. Memory swapping of memory pages using the physical memory and the virtual memory is known to one skilled in the art.

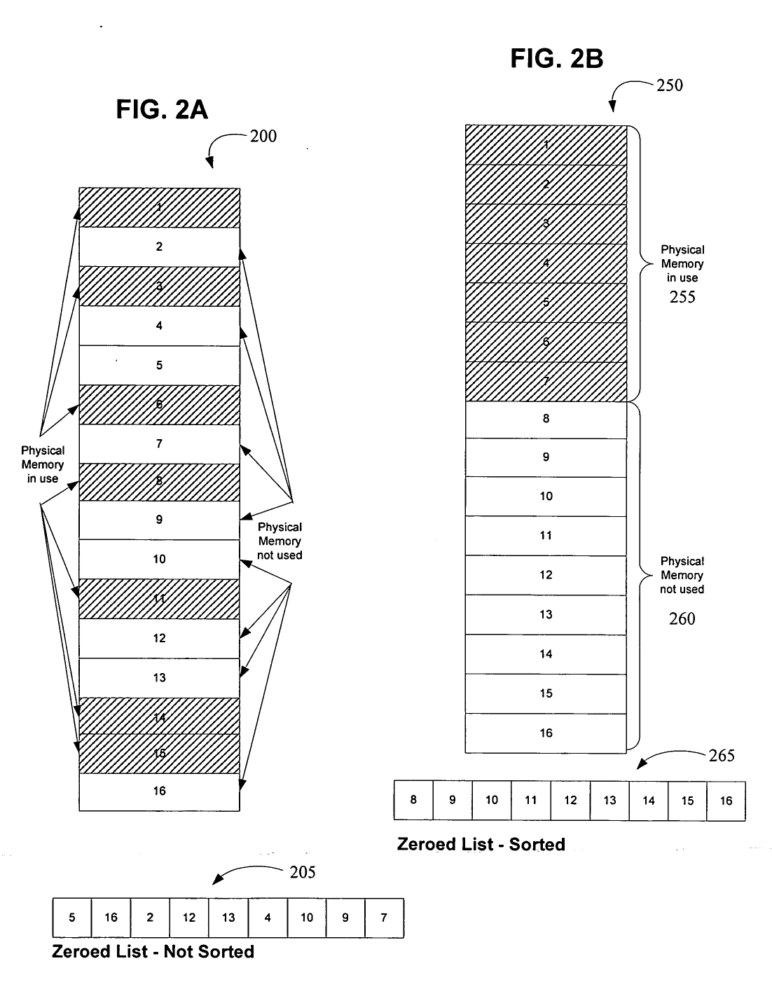

FIG. 2A is a block diagram illustrating one example of a physical memory in a computer system, in accordance with one embodiment. Physical memory 200 in this example may include 16 memory pages numbered 1 to 16 with the memory page 1 being associated with a lower memory address and the memory page 16 being associated with a higher memory address. Some of these memory pages may be in use, while others may not. For example, as illustrated in FIG. 2A, the memory pages that are in use are shaded and include memory pages 1, 3, 6, 8, 11, 14 and 15. The memory pages that are not in use are not shaded and include memory pages 2, 4, 5, 7, 9, 10, 12, 13 and 16.

The OS may keep track of the status of each memory page by using a Page Frame Number (PFN) database (not shown). The PFN database may contain linked lists of memory pages based on some specific states. Some of these linked lists include a zeroed list and a free list. The zeroed list is a list of memory pages that are not in use, have been initialized with zeros and are ready or available for allocation by the OS. A pointer may be used to identify the end of the zeroed list. Allocation of a memory page from the zeroed list may be made from the beginning of the zeroed list which may be identified by another pointer.

After a memory page from the zeroed list is allocated, used, and no longer needed, that memory page may become a free memory page. The free memory page may be added to the end of the free list. A pointer may be used to identify the end of the free list. It may be noted that the free list is different from the zeroed list in that the free list may include memory pages that are not in use but are not available. The OS may allocate the free memory pages only after they are initialized or zeroed out. When a free memory page is initialized, it may then be added to the end of the zeroed list. Transferring a memory page from the free list to the zeroed list may be made from the beginning of the free list.

At any one time, a memory page may be allocated from the zeroed list or added to the free list. As such, the memory addresses associated with the memory pages in the free list may not be contiguous and may be scattered all over the range of the physical memory. Because these free memory pages are added to the zeroed list after they are initialized, the available memory pages in the zeroed list may also be scattered all over the range of the physical memory, as illustrated in the zeroed list 205 of FIG. 2A.

Sorting of Memory Pages in the Zeroed and Free Lists

For one embodiment, the memory pages in the zeroed list may be arranged or sorted sequentially. The zeroed list may be sorted in an ascending sequence with the memory page having the lowest address positioned at the beginning of the zeroed list. For another embodiment, the zeroed list may be sorted whenever a memory page is to be added to the zeroed list. Having a sorted zeroed list may be advantageous because the memory pages associated with lower memory addresses may be allocated by the OS before the memory pages associated with higher memory addresses.

For another embodiment, the free list may also be sorted sequentially with the free memory page associated with the lowest memory address positioned at the beginning of the free list. This may also be advantageous because the memory page associated with the lowest memory address in the free list may be a next memory page that is transferred to the zeroed list.

FIG. 2B is a block diagram illustrating one example of the memory in a computer system that uses a sorted zeroed list, in accordance with one embodiment. Physical memory 250 is similar to the physical memory 200 illustrated in FIG. 2A, except for the difference in the addresses associated with the memory pages that are in use and those that are not in use. Using a sorted zeroed list such as, for example, the zeroed list 265, allocated memory pages may be less scattered over the memory 250 and may be positioned more toward a lower memory address area 255 of the memory 250. Similarly, using the sorted zeroed list may enable zeroed memory pages to be positioned more toward a higher memory address area 260 of the memory 250 as compared to being scattered all over.

Memory Element Power Reduction

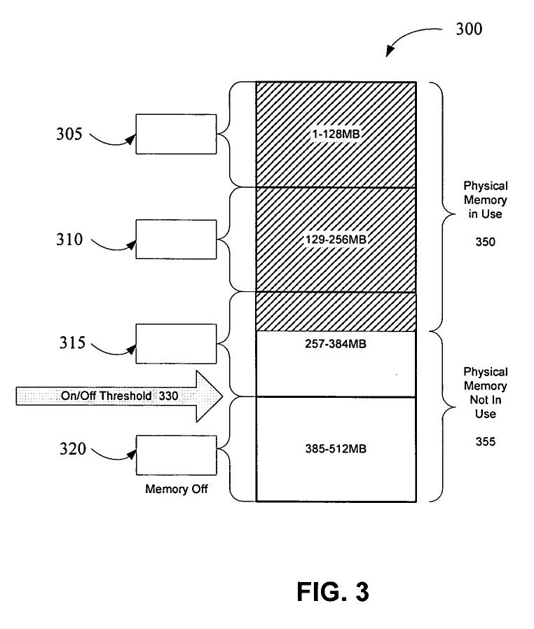

FIG. 3 is a block diagram illustrating one example of a physical memory and associated memory elements, in accordance with one embodiment. In this example, physical memory 300 has a size of 512 MB and includes four memory elements 305-320. Although each of the four memory elements is illustrated as having a similar capacity of 128 MB, it may be possible that they may have different capacities. By using the sorted zeroed list or the combination of the sorted zeroed list and the sorted free list to allocate memory pages, the allocated or in-use memory pages are positioned in the lower address area 350 (shaded area) of the physical memory 300, and the available but not allocated memory pages are positioned in the higher address area (non-shaded area) 355. In this example, the lower address area 350 is associated with the memory elements 305-315, and the higher address area 355 is associated with the memory elements 315-320. It may be noted in this example that not all of the memory pages associated with the memory element 315 are allocated.

For one embodiment, the power consumption of any memory elements that are not associated with an in-use memory page may be reduced. For example, when the computer system 100 is in a low power consumption state, it may be less likely that the memory element 320 will be needed, and as such, the power consumption of the memory element 320 may be reduced from its normal power consumption state. Reducing the power consumption of a memory element may include, for example, reducing the supplied voltage, frequency, etc. to a lower value or possibly down to zero. Reducing the power consumption of a memory element that is not associated with an in-use memory page may help reducing the overall power consumption of the computer system 100 and enhancing the battery life. A memory element that is associated with at least one in-use memory page may remain in its normal power consumption state.

For one embodiment, a threshold address may be used in order to determine one or more memory elements that are not associated with an in-use memory page. The threshold address may be set by the OS and may depend on the capacity of the memory elements. For example, the threshold address may be set at 385 MB to correspond to a memory address associated with the memory element 320. For another embodiment, the OS may set multiple threshold addresses. For example, each of the threshold addresses may be associated with a memory element 310, 315 or 320.

For one embodiment, the available memory pages in the sorted zeroed list may be compared with the threshold address to determine the memory element(s) that may have its power consumption reduced. For example, when the starting address of a memory page at the top of the sorted zeroed list (i.e., a next memory page that may be allocated) is less than the threshold address, the power consumption of the memory element(s) associated with memory addresses equal to or higher than the threshold address may be reduced.

It may be possible that OS may allocate memory pages from the sorted zeroed list as a set of one or more memory pages. For example, depending on the application, the OS may allocate ten memory pages at a time while keeping the memory pages allocated to the application within a certain factor (e.g., 10 MB). As such, the power consumption of the memory elements affected by the allocation of the set of memory pages may not be reduced. If the power consumption of the affected memory elements were previously reduced, they may need to be restored. For one embodiment, when the computer system returns to a normal power consumption state (e.g., C0 state) from a low power consumption state (e.g., C1, C2, or C3 state), the power consumption is restored to all of the memory elements that were previously reduced.

Flow Diagram

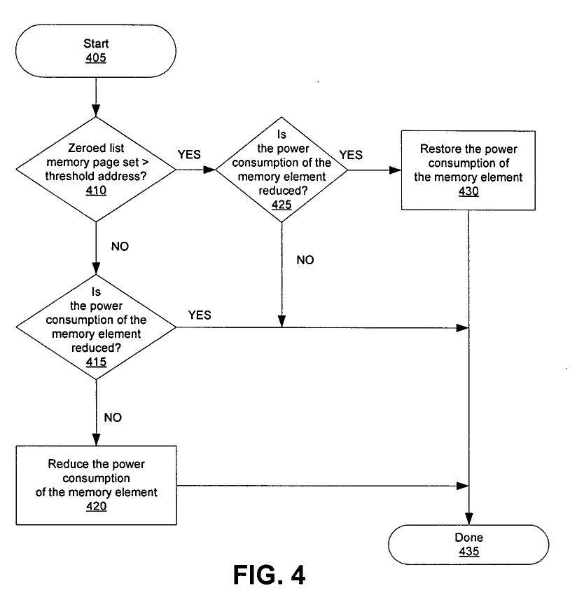

FIG. 4 is a flow diagram illustrating one example of a process that may be used to identify a memory element that may have its power consumption reduced or restored, in accordance with one embodiment. The process may start at block 405. At block 410, the address of the memory page set at the top of the sorted zeroed list may be compared with the threshold address. When the address is equal or higher than the threshold address, the process may flow to block 425 where the power consumption of the memory element associated with the memory page set is verified. If the power consumption was previously reduced, then it is to be restored, as shown in block 430. If the power consumption of the memory element was not previously reduced, then it is to remain the same, and the process may flow to block 435.

From block 410, when the address is less than the threshold address, this may mean that there is a surplus of available memory pages at addresses lower than the threshold address. The process may then flow to block 415 where the power consumption of the memory element associated with the memory page set is verified. If the power consumption was previously reduced, then it is to remain the same and the process may flow to block 435. However, if the power consumption of the memory element was not previously reduced, then it is to be reduced, as shown in block 420. For one embodiment, it may be necessary to relocate memory pages associated with addresses higher than the threshold address to addresses lower than the threshold address.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method, comprising:
allocating memory pages associated with lower memory addresses before memory pages associated with higher memory addresses; and
reducing power consumption of a memory element that does not include an allocated memory page.

2. The method of claim 1, wherein the memory pages to be allocated have been initialized and are available to be allocated by an operating system (OS).

3. The method of claim 2, wherein the memory pages to be allocated have been arranged in a sequence based on the associated memory addresses.

4. The method of claim 3, wherein the memory element includes one or more memory pages.

5. The method of claim 4, wherein the memory element is a collection of one or more memory chips.

6. The method of claim 4, wherein reducing the power consumption of the memory element that does not include an allocated memory page comprises relocating an allocated memory page from a first memory element to a second memory element to reduce the power consumption of the first memory element.

7. The method of claim 6, wherein reducing the power consumption of the memory element that does not include an allocated memory page comprises:
comparing a threshold address with an address associated with a memory page available to be allocated next; and
reducing the power consumption of the memory element having memory pages associated with memory addresses higher than the threshold address.

8. The method of claim 7, wherein the threshold address is provided by the OS.

9. The method of claim 7, further comprising:
restoring the power consumption of the memory element having memory pages associated with memory addresses lower than the threshold address if the power consumption of these memory elements was previously reduced.

10. The method of claim 7, wherein the power consumption of the memory element is reduced when the computer system enters a low power consumption state.

11. The method of claim 10, wherein the power consumption of the memory element is restored when the computer system exits the low power consumption state.

12. A machine-readable medium including machine readable instructions that, if executed by a computer system, cause the computer system to perform a method comprising:
sorting memory pages that are available to be allocated, wherein sorting is based on memory addresses; and
allocating a memory page associated with a lowest memory address next.

13. The machine-readable medium of claim 12, further comprising:
reducing power consumption of a memory element having no allocated memory pages when the system is in a low power consumption state.

14. The machine-readable medium of claim 13, wherein the memory element includes multiple memory pages and is comprised of one or more memory chips.

15. The machine-readable medium of claim 14, further comprising:
restoring the power consumption of the memory element having no allocated memory pages when the system is in a normal power consumption state.

16. A system, comprising:
a processor; and
a memory coupled to the processor, wherein the memory includes memory elements each having multiple memory pages, and wherein power consumption of a memory element is reduced when it has no allocated memory pages.

17. The system of claim 16, wherein the power consumption of the memory element is reduced when the processor is in a low power consumption state.

18. The system of claim 17, wherein the memory pages are sorted based on their associated memory addresses before being allocated.

19. The system of claim 17, wherein a memory page associated with a low memory address is allocated before a memory page associated with a high memory address.

20. The system of claim 19, wherein a threshold address provided by an operating system (OS) is used to determine the memory element having its power consumption reduced.

21. The system of claim 20, wherein the threshold address is compared with the memory addresses associated with the sorted but not allocated memory pages.
